(19) United States
(12) Patent Application Publication
(10) Pub. No.: US 2025/0201237 A1
(43) Pub. Date: Jun. 19, 2025

(54) SPLIT-AND-MERGE FRAMEWORK FOR AUDIO CONTENT PROCESSING

(71) Applicant: PayPal, Inc., San Jose, CA (US)

(72) Inventors: Panpan Qi, Singapore (SG); Zhe Chen, Singapore (SG); Quan Jin Ferdinand Tang, Singapore (SG)

(21) Appl. No.: 18/541,788

(22) Filed: Dec. 15, 2023

(51) Int. Cl. G10L 15/08; G10L 21/0272; G10L 25/51

(52) U.S. Cl. CPC G10L 15/08; G10L 21/0272; G10L 25/51

(57) ABSTRACT

Methods and systems are presented for providing a framework for analyzing and classifying audio data using a split-and-merge approach. Audio data is split into multiple audio tracks that correspond to different characteristics. Each audio track is segmented, and features are extracted from each segment of the audio track. Features extracted from audio segments of each audio track is analyzed. One or more correlations between the different audio tracks are determined based on comparing features extracted from audio segments of a first audio track against features extracted from audio segments of a second audio track. The audio data is classified based on the one or more correlations.

### BACKGROUND

The present specification generally relates to audio processing, and more specifically, to classifying audio data according to various embodiments of the disclosure.

### Related Art

Online service providers such as online merchants, social media platforms, and others alike have enabled users to submit content to be shared with other users through sites hosted by the online service providers. For example, a user of a social media platform may post a user-generated text, audio clip, and/or video clip on a social media website for sharing with other users. In another example, a customer of an online merchant may post a review of a product that includes a video of the product. Since the content is published and shared through sites (e.g., websites, mobile applications, etc.) that are hosted by the service provider, the service provider may be required to ensure that the user-submitted content complies with any local laws or regulations and/or internal policies of the service provider (e.g., whether the content includes offensive speech such as hate speech, speech that implies violent actions, speech that involves sexual content, speech that includes sensitive data such as health data, personal identifiable information (PII), etc.). As such, when the service provider receives content submitted by a user, the service provider may first classify the user-submitted content (e.g., determining whether the user-submitted content complies with the local laws or regulations and/or internal policies of the service provider), and may publish the user-submitted content on the sites only if the user-submitted content is classified as being in compliance with the local laws or regulations and/or internal policies.

Classifying audio data (e.g., data that includes audio content) is typically more challenging than classifying text data (or even visual data), due to the complexity of analyzing and processing audio data. Conventionally, audio data is analyzed in a single dimension (as a single source of information). Due to the rich information typically included in audio data, such an approach often produces inaccurate classification results that can result in posting unlawful content or not posting useful content. Thus, there is a need for a more robust framework for comprehensively analyzing and classifying audio data.

### BRIEF DESCRIPTION OF THE FIGURES

FIG. 1 is a block diagram illustrating an electronic transaction system according to an embodiment of the present disclosure;

FIG. 2 is a block diagram illustrating a content analysis module according to an embodiment of the present disclosure;

FIG. 3 illustrates an example dataflow for splitting and segmenting audio content according to an embodiment of the present disclosure;

FIG. 4 illustrates an example dataflow for extracting features from audio segments according to an embodiment of the present disclosure;

FIG. 5 illustrates an example dataflow for determining correlations among different audio tracks according to an embodiment of the present disclosure;

FIG. 6 illustrates an example process for classifying audio data according to an embodiment of the present disclosure;

FIG. 7 illustrates an example neural network that can be used to implement a machine learning model according to an embodiment of the present disclosure; and

FIG. 8 is a block diagram of a system for implementing a device according to an embodiment of the present disclosure.

Embodiments of the present disclosure and their advantages are best understood by referring to the detailed description that follows. It should be appreciated that like reference numerals are used to identify like elements illustrated in one or more of the figures, wherein showings therein are for purposes of illustrating embodiments of the present disclosure and not for purposes of limiting the same.

### DETAILED DESCRIPTION

The present disclosure describes methods and systems for providing a framework for analyzing and classifying audio data using a split-and-merge approach. As discussed here, in order to increase user interactions and/or provide improved user experienced on their platforms, many online service providers have enabled their users to submit content that may be shared with other users via the sites associated with the online service providers. The content may include single source data (e.g., text data, image data, audio data) and/or multimedia data (e.g., data that includes two or more of text data, audio data, image data, etc.). For example, a social media platform may enable its users to post content to be shared with other users on the social media website. In another example, a customer of an online merchant may post a review of a product that the consumer recently purchased. Before publishing the user-submitted content to be shared with other users, the online service provider may analyze the user-submitted content to ensure that the user-submitted content is not in violation of any local laws or regulations and/or internal policies associated with the online service provider. For example, the local laws or regulations and/or the internal policies may prohibit publishing and/or sharing of content that includes offensive language, violent actions, sexual content, sensitive data such as health information, personal identifiable information (PII), etc.

As such, the online service provider may first classify each user-submitted content (e.g., determining whether the user-submitted content includes the prohibited content, etc.), and may determine whether to publish the user-submitted content based on the classification. The online service provider may publish the user-submitted content on its sites if the user-submitted content is classified as compliant (e.g., determining that the user-submitted content does not include any prohibited content, etc.). Once the user-submitted content is published, users of the online service provider may access (e.g., view, download, re-share, etc.) the user-submitted content through one or more sites of the online service provider. On the other hand, if the user-submitted content is classified as non-compliant, the online service provider may not publish the user-submitted content. In addition, the online service provider may also flag the content (or a portion of the content that is in violation of the laws/policies), and have a human reviewer (or another computer module) perform a further review and/or further processing of the user-submitted content. The flagging of the content (or a portion of the content) may include selectively modifying one or more portions of the content (e.g., the audio data) to indicate that the content (or a portion of the content) includes data that is non-compliant with a local law or regulation and/or a policy associated with the online service provider.

Analyzing audio data can be challenging because audio data, unlike text data, contains rich information. Specifically, an audio clip or a video clip may include multiple layers of sound (e.g., sound produced by different sources such as different people or different objects, etc.) that may or may not overlap with each other. For example, the audio data may include voice data associated with one or more persons speaking in the foreground (e.g., the main speaker(s), etc.). The audio clip or audio accompanying a video clip may also include different background sound (e.g., people other than the main speaker(s) chatting in the background, ambient sound, sound caused by other people or other objects in the vicinity of the main speaker, etc.).

The conventional approach to analyzing and classifying audio data treats the audio data as a single source. That is, under the conventional approach, the audio data is analyzed as a whole, regardless of the actual source of the sound and whether the sound corresponds to the main speech or background sound. While different aspects of the audio data, such as human speech data, environmental data, sentiment data, etc. can still be derived using such an approach, the analysis and the resulting classification lacks precision and accuracy. It is because certain words or sounds may carry different meanings based on the context and the circumstances in which the words or the sounds were produced. For example, the sound of someone falling onto the ground may indicate that a violent event has occurred (e.g., someone was physically assaulted by another person), or that the person merely tripped and fell onto the ground. In another example, a person reciting a series of numbers may indicate that the person is giving out sensitive information (e.g., a credit card number, a social security number, etc.), or that the person is reciting random numerals. By analyzing the audio data as a single source of information, the context may not be accurately detected due to the noise in the audio data or the lack of data to verify a detected context (e.g., unable to or inaccurately determine whether a violent event has occurred based on the sound of someone falling onto the ground).

As such, according to various embodiments of the disclosure, an audio analysis framework may use a split-and-merge approach to analyze the audio data. Under the split-and-merge approach, the audio data may be decomposed into multiple layers of sound. In some embodiments, each layer of sound may be treated as a distinct audio track. For example, since the audio data may include voice data associated with one or more persons speaking in the foreground (e.g., the main speaker(s), etc.), an audio analysis system may extract the voice of the one or more speakers from the audio data as an audio track corresponding to the foreground speech of the content. In some embodiments, when there are multiple speakers in the foreground, the audio analysis system may treat the voice from each speaker as a distinct audio track. Since the speakers may talk sequentially or sometimes simultaneously, overlapping each other's voice, there may be benefits in analyzing the speech for different speakers individually as separate audio tracks. Similarly, the audio analysis system may separate the background sound from the foreground voice, and treat the background sound as a separate audio track. In some embodiments, the audio analysis system may also determine whether there are multiple sources of background sound (e.g., music playing in the background, chatter from people other than the main speakers, sound produced by background objects, etc.), and may treat sound from different sources as distinct audio tracks.

The audio analysis system may initially analyze the different audio tracks (e.g., a foreground speech audio track, a background audio track, etc.) individually. To analyze an audio track, the audio analysis system may divide the audio track into multiple segments. In some embodiments, the audio analysis system may determine a segment duration (e.g., 3 seconds, 5 seconds, etc.), and may divide each audio track into multiple segments based on the segment duration, such that each audio segment comprises audio data for the determined duration (or less). After segmenting each audio track, the audio analysis system may extract features from each audio segment.

In some embodiments, the audio analysis system may use one or more machine learning models to extract features (e.g., embeddings such as vectors in a multi-dimensional space) from each audio segment based on characteristics associated with the corresponding audio track. For example, the audio analysis system may use one or more machine learning models and/or techniques (e.g., a Mel Spectrogram, a Mel-Frequency Cepstral Coefficients (MFCC), convolutional neural networks (CNNs), etc.) to generate time-frequency representations of the sound in each audio segment. The audio analysis system may also use one or more machine learning models (e.g., a speech recognition model such as a wav2vec2 transformer model, a wav2vec2 conformer model, etc.) to extract speech data from each audio segment. In some embodiments, the audio analysis system may use multiple models to extract different types of features from each of the audio segments. By using multiple models to extract different types of features from each audio segment, the audio analysis system may analyze different aspects of the sound within the audio segment. For example, the audio analysis system may use a speech recognition model to extract speech data from an audio segment. The audio analysis system may also use another machine learning model (e.g., a Mel Spectrogram model, a MFCC model, a CNN, etc.) to extract additional features corresponding to other aspects (e.g., a sentiment aspect, an environmental aspect, etc.) from the same audio segment. The combination of different types of features extracted from the same audio segment enables the audio analysis system to analyze the sound within the audio segment more comprehensively than using a single type of feature.

In some embodiments, the audio analysis system may also select different models for extracting features from different audio segments based on the characteristics of the audio segments. For example, the audio analysis system may select a Mel-Spectrogram model for extracting features from an audio segment that tend to include a different types of sound (e.g., audio segments that correspond to background sound track, etc.). Since the Mel-Spectrogram model is configured to transform audio signal into a multi-dimensional visualization that captures the spectrogram according to the Mel scale of the audio signal, the features generated by the Mel-Spectrogram model provide information similar to what a human may perceive from the audio data. This is useful for analyzing general sound as the features provide comprehensive information about the sound, which may then be used to derive different data, such as speech data, sentiment data, environment data, action data, etc. On the other hand, the audio analysis system may select a MFCC model for extracting features from an audio segment that includes mostly a single type of sound, such as human speech (e.g., audio segments that correspond to a foreground speech audio track, etc.). Similar to the Mel-Spectrogram model, the MFCC model is also a model that is based on the Mel scale. The MFCC model may be derived from the Mel-Spectrogram model, and is configured to provide a more compressed representation of the audio signal than the Mel-Spectrogram model. By retaining only the most relevant and important information, the MFCC model is generally more efficient than the Mel-Spectrogram model, even though the outputs from the MFCC model may not be as comprehensive as the Mel-Spectrogram model. As such, the audio analysis system may select the MFCC model for audio segments that include mostly human speech as human speech has more structure and is less complex to analyze than other types of sound. In some embodiments, instead of using Mel-based model to extract features from the vocal and/or background audio segments, the audio analysis system may also select one or more other types of machine learning models (e.g., CNNs, etc.) for extracting features from the vocal and/or background audio segments.

In some embodiments, the audio analysis system may analyze the features generated by the various machine learning models based on the audio segments. Since the audio segments from each audio track correspond to different time periods of the same content, it has been contemplated that the audio segments may be related to one another (e.g., the audio segments may represent different portions of a speech made by a speaker). In particular, each audio segment may be associated with a temporal element (e.g., a particular timestamp, a particular time period in the entire audio track, etc.) in relation to the entire audio track. As such, when analyzing a particular audio segment and/or a particular audio track, the audio analysis system of some embodiments may analyze the features extracted from the particular audio segment in relation to features of one or more audio segments that are related to the particular audio segment along a temporal dimension (e.g., audio segments that come immediately before or after the particular audio segment in the audio track, etc.). In some embodiments, the audio analysis system may use a recurrent neural network (e.g., a gated recurrent unit (GRU), etc.) to transform the features extracted from the audio segments associated with an audio track to temporal dependent features. For example, the audio analysis system may provide the features associated with the audio segments, one audio segment at a time, to the recurrent neural network. The recurrent neural network may be configured to analyze the features based on the timestamps associated with the features. When features associated with the first audio segment are analyzed by the recurrent neural network, the recurrent neural network may analyze the features associated with the first audio segment, and generate a set of temporal dependent features for the first audio segment. The recurrent neural network may then analyze features associated with a second audio segment based on the timestamp associated with the features in the second audio segment (which comes immediately after the first audio segment in the audio track). The recurrent neural network may analyze the features associated with the second audio segment in relation to the features associated with the first audio segment, and may generate a set of temporal dependent features for the second audio segment based on the features associated with the first audio segment and the features associated with the second audio segment.

The recurrently neural network may continue to analyze subsequent audio segments to the recurrent neural network. The recurrent neural network may analyze each audio segment based on the features associated with the audio segment and the features associated with one or more previous audio segments (e.g., all of the previously provided audio segments for the audio track, etc.) to generate a set of temporal dependent features for the audio segment. Since the recurrent neural network takes into account features associated with previous audio segments when analyzing a particular audio segment, the recurrent neural network may use the context derived from the previous audio segments to generate the temporal dependent features for the particular audio segment.

In some embodiments, the recurrent neural network may be configured to analyze the features associated with the different audio segments in a bi-directional manner. That is, when analyzing the features associated with a particular audio segment, the recurrent neural network may take into account features that comes before and also after the features associated with the particular audio segment (e.g., features associated with audio segments that come before the particular audio segment and features associated with audio segments that come after the particular audio segment).

In some embodiments, the recurrent neural network mechanism can be applied for among the features within each segment as well. In this case, for example, for the first timestamp in the second segment, the temporal dependent features generated for the first timestamp could depend on the input feature of this timestamp and the feature vector(s) (e.g., the temporal dependent features) generated for the previous timestamp (e.g., a previous timestamp in the second segment, the last timestamp in the first segment, etc.), as this feature vector(s) (e.g., the temporal dependent features) summarize the information of the previous timestamp and/or the previous segment. By doing this, the temporal relations of the segments can be taken into account.

As such, the temporal dependent features generated for each particular audio segment may represent the characteristics of the audio signals within the audio segment using the context of the audio signals from the audio segment(s) that comes before it and/or the audio signals from the audio segment(s) that comes after it. Generating temporal dependent features for the audio segments is advantageous because it is generally more accurate to understand and/or decipher a sound (e.g., a word, a phrase, a noise, etc.) with information related to the sound that precedes it (e.g., the words or phrase that precedes it, a sound that precedes it, etc.) and/or sound that comes after it. For example, an audio segment that includes the sound of a gunshot may indicate that a violent event has occurred, or that a television in the background was broadcasting an action movie on the television. Analyzing that audio segment in a vacuum may not yield a definitive answer. However, the sound that precedes the audio segment may provide additional context (e.g., lots of people screaming or not, different style of people talking suggesting a change of television channels, etc.) to aid the recurrent neural network and/or the audio analysis system to understand the sound in this audio segment.

In some embodiments, the audio analysis system may use the recurrent neural network to analyze the audio segments of each audio track separately. For example, the audio analysis system may provide features of the audio segments corresponding to the foreground speech audio track to generate temporal dependent features for the audio segments of the foreground speech audio track. The audio analysis system may then provide features of the audio segments corresponding to the background audio track to generate temporal dependent features for the audio segments of the background audio track. In some embodiments, when different models (e.g., a Mel-based model and a speech recognition model, etc.) are used to extract features from audio segments of an audio track, the audio analysis system may also generate separate sets of temporal dependent features for the same audio track based on the features generated using the different models. Thus, the audio analysis system may use a recurrent neural network to generate first temporal dependent features for an audio track based on features extracted from the audio segments using a first model (e.g., a Mel-based model, etc.), and may use a recurrent neural network (which may be the same or a different recurrent neural network than the one used for generating the first temporal dependent features) to generate second temporal dependent features for the audio track based on features extracted from the audio segments using a second model (e.g., a speech recognition model, etc.).

In some embodiments, once the temporal dependent features are generated for each audio track, the audio analysis system may determine correlations between the different audio tracks based on the temporal dependent features. For example, background sound associated with people fighting (e.g., shoving, pushing, falling, etc.) often accompanies offensive language in a scene where someone is being bullied. In another example, background sound that corresponds to a person falling onto the ground that accompanies offensive language may indicate that a violent event (e.g., a physical altercation between two people) is happening. On the other hand, the same background sound that corresponds to a person falling onto the ground that accompanies voices made by people caught in surprise may indicate that the person might have fallen onto the ground by accident. Thus, the correlations between the different audio tracks (e.g., whether the sound from one audio track supports or contradicts the sound from another audio track) may enable the audio analysis system to detect the events that occur within the audio data more accurately, and provide a more accurate classification as a result.

In some embodiments, the audio analysis system may use a cross attention module to determine correlations (or lack thereof) between different audio tracks. The cross attention module may be configured to accept temporal dependent features associated with different audio tracks. For example, the audio analysis system may provide temporal dependent features associated with a primary audio track (e.g., a background audio track) and temporal dependent features associated with a secondary audio track (e.g., a foreground speech audio track) as input data to the cross attention module. The cross attention module may be configured to analyze (and modify) the temporal dependent features associated with the primary audio track based on the temporal dependent features associated with the secondary audio track.

For example, if the cross attention module determines that the temporal dependent features associated with the secondary audio track support one or more of the temporal dependent features associated with the primary audio track (e.g., the context determined based on the audio segments from the secondary audio track is consistent with one or more of the temporal dependent features associated with the primary audio track, such as when the offensive language included in the foreground speech audio track is consistent with a feature that suggests a violent event based on the background sound), the cross attention module may emphasize and/or highlight the one or more of the temporal dependent features. On the other hand, if the cross attention module determines that the temporal dependent features associated with the secondary audio track contradicts with one or more of the temporal dependents features associated with the primary audio track (e.g., the context determined based on the audio segments from the secondary audio track is inconsistent with one or more of the temporal dependent features associated with the primary audio track, such as when the calm or surprised voice and non-offensive language included in the foreground speech audio track is inconsistent with a feature that suggests a violent event based on the background sound), the cross attention module may deemphasize and/or remove the one or more of the temporal dependent features.

The cross attention module may output context-aware features associated with the primary audio track based on modifying the temporal dependent features. Based on the correlation processing performed by the cross attention module, the temporal dependent features associated with the primary audio track have been modified to reflect the correlations detected between the primary audio track and the secondary audio track, such that the context aware features associated with the primary audio track have become more accurate in representing the events occurred when the audio data was captured. In some embodiments, the audio analysis system may use the cross attention module to repeat the same process (e.g., perform a second iteration of the correlation process) by switching the primary audio track and the secondary audio track. Thus, the primary audio track used in the first iteration becomes the secondary audio track, and the secondary audio track used in the first iteration becomes the primary audio track in the second iteration. By performing the correlation process in multiple iterations using different audio tracks as the primary audio track, the audio analysis system may generate context-aware features for each of the audio tracks associated with the audio data.

For the cases where more than two audio tracks are generated based on the audio data (e.g., multiple foreground speech audio tracks, multiple background audio tracks, etc.), the audio analysis system may identify one of the audio tracks as the primary audio track in each iteration, and may use the remaining audio tracks as the secondary audio tracks. The temporal dependent features associated with the primary audio track and the temporal dependent features associated with the multiple secondary audio tracks may then be provided to the cross attention module as input data, and the temporal dependent features associated with the primary audio track may be modified based on correlations between the primary audio track and each of the secondary audio tracks.

In some embodiments, the audio analysis system may generate a speech classification and a non-speech classification based on the context-aware features associated with the different audio tracks. For example, the audio analysis system may generate the speech classification using the context-aware features associated with one or more speech audio tracks (e.g., foreground speech audio tracks) generated by the cross attention module, and may generate the non-speech classification using the context-aware features associated with one or more non-speech audio tracks (e.g., background audio tracks) generated by the cross attention module. The classifications may indicate whether the speech or non-speech portions of the audio data are in compliance with the local laws/regulations and/or the internal policies. The audio analysis system may then classify the audio data based on the speech classification and the non-speech classification.

If the audio analysis system determines that the audio data is in compliance with the local laws/regulations and/or the internal policies, the audio analysis system may cause the publishing of the audio data to a site (e.g., a website, a mobile application, etc.) associated with the online service provider. On the other hand, if the audio analysis system determines that the audio data is not in compliance with the local laws/regulations and/or the internal policies, the audio analysis system may not publish the audio data on the site. The audio analysis system may also transmit the audio data to another computer module (or a human reviewer) for further processing of the audio data (e.g., to scrub the audio data, to remove the sound that is not in compliance with the laws/regulations, etc.).

In some embodiments, when the speech classification and/or the non-speech classification indicates that one or more portions of the audio data include non-compliant sound, the classifications may also indicate which portion(s) (e.g., which audio segments) include the non-compliant sound. The audio analysis system may flag that portion(s) (e.g., the audio segment(s)) in the audio data. For example, the audio analysis system may modify that particular audio segment(s) (e.g., adding an indicator such as a specific alarm or beep to the audio segment(s), adding a visual indicator on the corresponding video portion of a video clip, etc.) before transmitting the audio data (or video data) to the other computer module for further processing. In some embodiments, the modifications may be performed to avoid altering any of the pre-existing content in the audio data, such that the original audio content may be retained in the audio data in addition to the indicator (e.g., the alarm or beep, etc.). In some embodiments, the modifications may alter the pre-existing content, for example, by removing and/or redacting audio content that has been classified to a particular classification (e.g., offensive content, unlawful content, content that includes sensitive data, etc.). Thus, using such a split-and-merge framework or approach for processing (classifying) audio data, more accurate classifications are possible, thereby preventing publishing undesired audio data and making sure desired audio data is published.

In some embodiments, generative artificial intelligence (e.g., ChatGPT by OpenAI®, etc.) may also be used in the process of classifying audio data. For example, the audio data that has been provided to the split-and-merge framework, the set of criteria used to classify the audio data, and the classification results generated by the split-and-merge framework may be used to generate training data to train a machine learning model (e.g., a large language model (LLM), etc.), such that the LLM may be configured and trained to generate redacted versions of various audio content based on any given set of criteria.

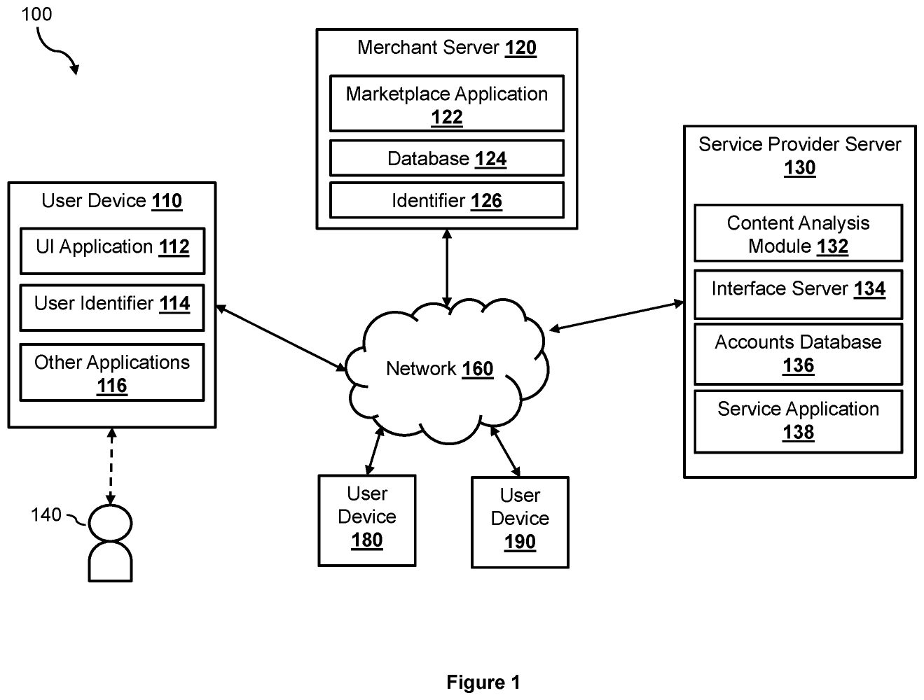

FIG. 1 illustrates an electronic transaction system 100, within which the audio analysis system may be implemented according to one embodiment of the disclosure. The electronic transaction system 100 includes a service provider server 130 that is associated with the online service provider, a merchant server 120, and user devices 110, 180, and 190 that may be communicatively coupled with each other via a network 160. The network 160 may be implemented as a single network or a combination of multiple networks. For example, the network 160 may include the Internet and/or one or more intranets, landline networks, wireless networks, and/or other appropriate types of communication networks. In another example, the network 160 may comprise a wireless telecommunications network (e.g., cellular phone network) adapted to communicate with other communication networks, such as the Internet.

The user device 110 may be utilized by a user 140 to interact with the merchant server 120 and/or the service provider server 130 over the network 160. For example, the user 140 may use the user device 110 to conduct an online transaction with the merchant server 120 via websites hosted by, or mobile applications associated with, the merchant server 120. The user 140 may also log in to a user account to access account services or conduct electronic transactions (e.g., data access, account transfers or payments, onboarding transactions, etc.) with the service provider server 130. The user device 110 may be implemented using any appropriate combination of hardware and/or software configured for wired and/or wireless communication over the network 160. In various implementations, the user device 110 may include at least one of a wireless cellular phone, wearable computing device, PC, laptop, etc.

The user device 110, in one example, includes a user interface (UI) application 112 (e.g., a web browser, a mobile payment application, etc.), which may be utilized by the user 140 to interact with the merchant server 120 and/or the service provider server 130 over the network 160. In one implementation, the user interface application 112 includes a software program (e.g., a mobile application) that provides a graphical user interface (GUI) for the user 140 to interface and communicate with the service provider server 130 and/or the merchant server 120 via the network 160. In another implementation, the user interface application 112 includes a browser module that provides a network interface to browse information available over the network 160. For example, the user interface application 112 may be implemented, in part, as a web browser to view information available over the network 160. Thus, the user 140 may use the user interface application 112 to initiate electronic transactions with the merchant server 120 and/or the service provider server 130.

The user device 110 may include other applications 116 as may be desired in one or more embodiments of the present disclosure to provide additional features available to the user 140. In one example, such other applications 116 may include security applications for implementing client-side security features, programmatic client applications for interfacing with appropriate application programming interfaces (APIs) over the network 160, and/or various other types of generally known programs and/or software applications. In still other examples, the other applications 116 may interface with the user interface application 112 for improved efficiency and convenience.

The user device 110 may include at least one identifier 114, which may be implemented, for example, as operating system registry entries, cookies associated with the user interface application 112, identifiers associated with hardware of the user device 110 (e.g., a media control access (MAC) address), or various other appropriate identifiers. In various implementations, the identifier 114 may be passed with a user login request to the service provider server 130 via the network 160, and the identifier 114 may be used by the service provider server 130 to associate the user with a particular user account (e.g., and a particular profile).

Each of the user devices 180 and 190 may include similar hardware and software components as the user device 110, such that each of the user devices 180 and 190 may be operated by a corresponding user to interact with the merchant server 120 and/or the service provider server 130 in a similar manner as the user device 110.

The merchant server 120 may be maintained by a business entity (or in some cases, by a partner of a business entity that processes transactions on behalf of business entity). Examples of business entities include merchants, resource information providers, utility providers, online retailers, real estate management providers, social networking platforms, a cryptocurrency brokerage platform, etc., which offer various items for purchase and process payments for the purchases. The merchant server 120 may include a merchant database 124 for identifying available items or services, which may be made available to the user device 110 for viewing and purchase by the respective users.

The merchant server 120 may include a marketplace application 122, which may be configured to provide information over the network 160 to the user interface application 112 of the user device 110. The marketplace application 122 may include a web server that hosts a merchant website for the merchant. For example, the user 140 of the user device 110 may interact with the marketplace application 122 through the user interface application 112 over the network 160 to search and view various items or services available for purchase in the merchant database 124. In addition, the user (e.g., the user 140 of the user device 110, users of the user devices 180 and 190, etc.) may submit additional content to the merchant website, such as review of a product that the user has purchased from the merchant in the past. The user-submitted content may include single source data and/or multimedia data. In some embodiments, the merchant server may publish the user-submitted content via the website.

The merchant server 120 may include at least one merchant identifier 126, which may be included as part of the one or more items or services made available for purchase so that, e.g., particular items and/or transactions are associated with the particular merchants. In one implementation, the merchant identifier 126 may include one or more attributes and/or parameters related to the merchant, such as business and banking information. The merchant identifier 126 may include attributes related to the merchant server 120, such as identification information (e.g., a serial number, a location address, GPS coordinates, a network identification number, etc.).

While only one merchant server 120 is shown in FIG. 1, it has been contemplated that multiple merchant servers, each associated with a different merchant, may be connected to the user devices 110, 180, and 190, and the service provider server 130 via the network 160. Further, while merchant server 120 is described in relation to products, merchant server 120 can be generalized to include servers associated with any entity that publishes user-submitted content on their websites or platforms, such as, but not limited to, social networking sites, professional networking sites, content sharing sites, and review sites.

The service provider server 130 may be maintained by a transaction processing entity or an online service provider, which may provide processing of electronic transactions between users (e.g., the user 140 and users of other user devices, etc.) and/or between users and one or more merchants. As such, the service provider server 130 may include a service application 138, which may be adapted to interact with the user device 110 and/or the merchant server 120 over the network 160 to facilitate the electronic transactions (e.g., electronic payment transactions, data access transactions, content postings, etc.) among users and merchants processed by the service provider server 130. In one example, the service provider server 130 may be provided by PayPal®, Inc., of San Jose, California, USA, and/or one or more service entities or a respective intermediary that may provide multiple point of sale devices at various locations to facilitate transaction routings between merchants and, for example, service entities. In another example, the service provider server 130 may be provided by any entity posting or publishing content on a platform, app, or website, such as a social networking site, a professional networking site, a content sharing site, a review site, and the like.

The service application 138 may include a payment processing application (not shown) for processing purchases and/or payments for electronic transactions (including publishing of content) between a user and a merchant or between any two entities (e.g., between two users, between two merchants, etc.). In one implementation, the payment processing application assists with resolving electronic transactions through validation, delivery, and settlement. As such, the payment processing application settles indebtedness between a user and a merchant, wherein accounts may be directly and/or automatically debited and/or credited of monetary funds in a manner as accepted by the banking industry.

The service provider server 130 may also include an interface server 134 that is configured to serve content (e.g., web content) to users and interact with users. For example, the interface server 134 may include a web server configured to serve web content in response to HTTP requests. In another example, the interface server 134 may include an application server configured to interact with a corresponding application (e.g., a service provider mobile application) installed on the user device 110 via one or more protocols (e.g., RESTAPI, SOAP, etc.). As such, the interface server 134 may include pre-generated electronic content ready to be served to users. For example, the interface server 134 may store a log-in page and is configured to serve the log-in page to users for logging into user accounts of the users to access various service provided by the service provider server 130. The interface server 134 may also include other electronic pages associated with the different services (e.g., electronic transaction services, etc.) offered by the service provider server 130. As a result, a user (e.g., the user 140, users of the user devices 180 and 190, or a merchant associated with the merchant server 120, etc.) may access a user account associated with the user and access various services offered by the service provider server 130, by generating HTTP requests directed at the service provider server 130. For example, the user (e.g., the user 140, the users of the user devices 180 and 190, etc.) may submit content to be shared with other users of the service provider server. The content may be related to a review or personal experience with a product or service offered by the service provider server 130 and/or the merchant server 120. The content may include various types of data, including single source data or multimedia data. The interface server 134 may publish the user-submitted content on a site (e.g., the website of the service provider server 130, a mobile application of the service provider server 130, etc.) so that other users of the service provider server 130 may access and view the user-submitted content.

The service provider server 130 may be configured to maintain one or more user accounts and merchant accounts in an accounts database 136, each of which may be associated with a profile and may include account information associated with one or more individual users (e.g., the user 140 associated with user device 110, users of the user devices 180 and 190, etc.) and merchants. For example, account information may include private financial information of users and merchants, such as one or more account numbers, passwords, credit card information, banking information, digital wallets used, or other types of financial information, transaction history, Internet Protocol (IP) addresses, device information associated with the user account. Account information may also include user purchase profile information such as account funding options and payment options associated with the user, payment information, receipts, and other information collected in response to completed funding and/or payment transactions.

In one implementation, a user may have identity attributes stored with (such as accounts database 136) or accessible by the service provider server 130, and the user may have credentials to authenticate or verify identity with the service provider server 130. User attributes may include personal information, including photos, date of birth, social security number, home address, banking information and/or funding sources. In various aspects, the user attributes may be passed to the service provider server 130 as part of a login, search, selection, purchase, and/or payment request, and the user attributes may be utilized by the service provider server 130 to associate the user with one or more particular user accounts maintained by the service provider server 130 and used to determine the authenticity of a request from a user device.

The service provider server 130 may also include a content analysis module 132 that implements at least the audio analysis system as discussed herein. In some embodiments, the content analysis module 132 may be configured to classify content based on a set of criteria (e.g., whether the content complies with laws and regulations, whether the content complies with internal policies associated with an organization, etc.). For example, when a user (e.g., the user 140, the users of the user devices 180 and 190, a user associated with the merchant server 120, etc.) submits content to the service provider server 130 via the interface provided by the interface server 134, the content analysis module 132 may be requested to classify the content based on a set of criteria. Since the set of criteria may be dependent on the locality from which the content was submitted, the interface server 134 of some embodiments may first determine the set of criteria for classifying the content. For example, if the content was submitted by a device within a geographical region (e.g., a country, a state, etc.), the interface server 134 may retrieve the laws and regulations associated with the geographical region, and may include the laws and regulations as part of the set of criteria. The interface server 134 may also retrieve internal policies of the service provider server 130 (and/or the merchant server 120) and include the internal policies as part of the set of criteria. The interface server 134 may then provide the user-submitted content along with the set of criteria to the content analysis module 132. The content analysis module 132 may then classify the content using the particular set of criteria.

In some embodiments, when the merchant server 120 receives content submitted by a user (e.g., the user 140, the users of the user devices 180 and 190, etc.) for sharing on the website of the merchant server 120, the merchant server 120 may request the content analysis module 132 to classify the user-submitted content according to a set of criteria. In some embodiments, the merchant server 120 may also provide the user-submitted content and the set of criteria to the content analysis module 132. Based on the classification of the user-submitted content, the service provider server 130 and/or the merchant server 120 may determine an action to perform for the user-submitted content. For example, if the user-submitted content is classified as a first classification (e.g., indicating that the user-submitted content is in compliance with the laws and internal policies), the service provider server 130 and/or the merchant server 120 may publish the user-submitted content via the corresponding site (e.g., the corresponding website, the corresponding mobile application, etc.), such that other users may access and view the user-submitted content via the corresponding site. On the other hand, if the user-submitted content is classified as a second classification (e.g., indicating that the user-submitted content is not in compliance with the laws or the internal policies, etc.), the service provider server 130 and/or the merchant server 120 may withdraw the user-submitted content from being published, or require that the user-submitted content be modified before publishing.

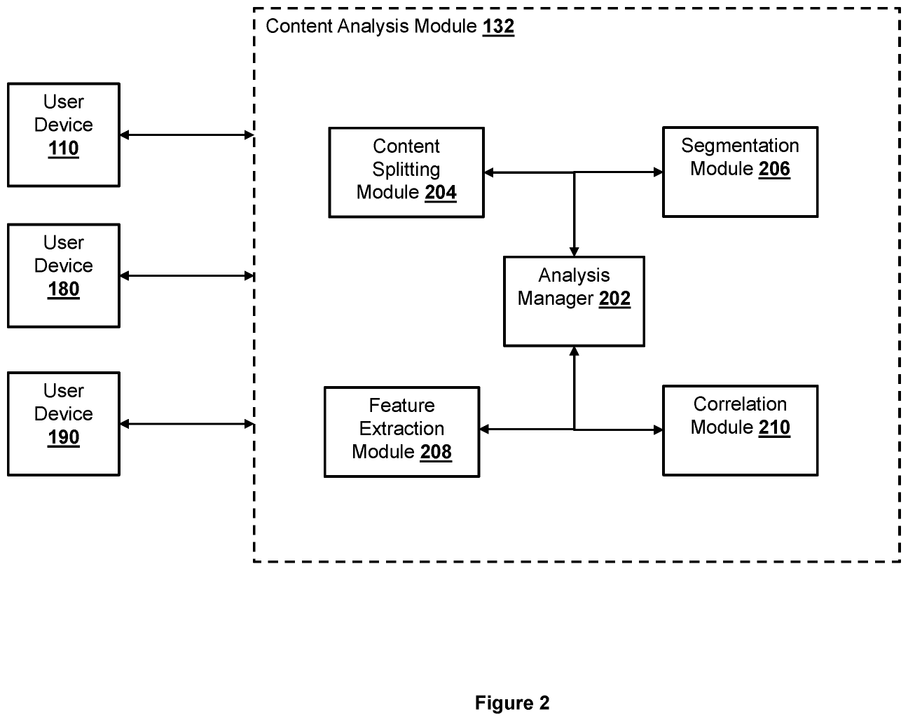

FIG. 2 is a block diagram illustrating the content analysis module 132 according to various embodiments of the disclosure. As shown, the content modification module 132 includes an analysis manager 202, a content splitting module 204, a segmentation module 206, a feature extraction module 208, and a correlation module 210. As discussed herein, users (the user 140 of the user device 110, the users of the user devices 180 and 190, users associated with the merchant server 120, etc.) may submit various types of content to be shared through interfaces provided by the service provider server 130 and/or the merchant server 120. The types of content may include single source data and/or multimedia data. Analyzing single source data and/or multimedia data that has audio data can be a challenge due to the rich information that is included in audio data. For example, unlike text data that is usually one dimensional, an audio clip or a video clip that includes audio data typically represents sound produced by multiple different sources, and the sound from the different sources sometimes overlap one another.

As such, the content analysis module 132 of some embodiments is configured to use a split-and-merge approach in analyzing and classifying audio data. The content analysis module 132 may receive a request to classify audio data. For example, upon receiving content submitted by a user, the interface server 134 may transmit a classification request to the content analysis module 132. The classification request may include the content submitted by the user and a set of criteria, which may be used by the content analysis module 132 to classify the content. In another example, the merchant server 120 may receive content submitted by a user, and the merchant server 120 may transmit a classification request to the content analysis module 132. The classification request may also include the content submitted by the user and a set of criteria. As such, the content analysis module 132 may dynamically classify different content based on different sets of criteria.

As discussed herein, due to the richness of information included in audio data, the content analysis module 132 may use a split-and-merge approach in analyzing and classifying audio data. Thus, when the content analysis module 132 receives a classification request, the content analysis module 132 may first extract any audio data from the content (e.g., extracting the audio data from an audio clip or a video clip, etc.), and may use the content splitting module 204 to divide the audio data into multiple audio tracks. Since the content submitted by users are typically generated by the users themselves in an uncontrolled environment (e.g., not in a sound-proof recording studio, etc.), the audio data typically includes sound from multiple sources. For example, the audio data may include one or more main speakers talking (e.g., describing a product or a service, etc.). However, depending on the location at which the audio data was captured, the audio data may also include other sound such as ambient sound (e.g., background music, other people talking in the background, sound made by the main speakers while talking, sound made by other objects in the background, etc.). As such, the analysis manager 202 may use the content splitting module 204 to divide the audio data into multiple audio tracks. In some embodiments, the content splitting module 204 may include a computer software program (e.g., Spleeter®, Audacity™, MP3DirectCut™, etc.) that is configured to analyze the frequencies (and/or the spectral elements) of different sound within the audio data to identify the multiple sound source, and split the audio data into multiple audio tracks corresponding to sound produced by the multiple sound sources.

The analysis manager 202 may then use the segmentation module 206 to segment each of the audio tracks into multiple audio segments. In some embodiments, the segmentation module 206 may segment an audio track based on a predetermined duration (e.g., 3 seconds, 5 seconds, etc.) or a dynamic duration, depending on the amount of sound, types of sound, the amount of different sounds, how often sound traits change, etc. After dividing each of the audio tracks into multiple audio segments, the analysis manager 202 may use the feature extraction module 208 to extract features from each of the audio segments. In some embodiments, the feature extraction module 208 may also use a recurrent neural network to generate temporal dependent features for each of the audio segments. The temporal dependent features may represent characteristics of a corresponding audio segment based on a context derived from other related audio segments (e.g., one or more audio segments that come before the corresponding audio segment in a chronological order, etc.).

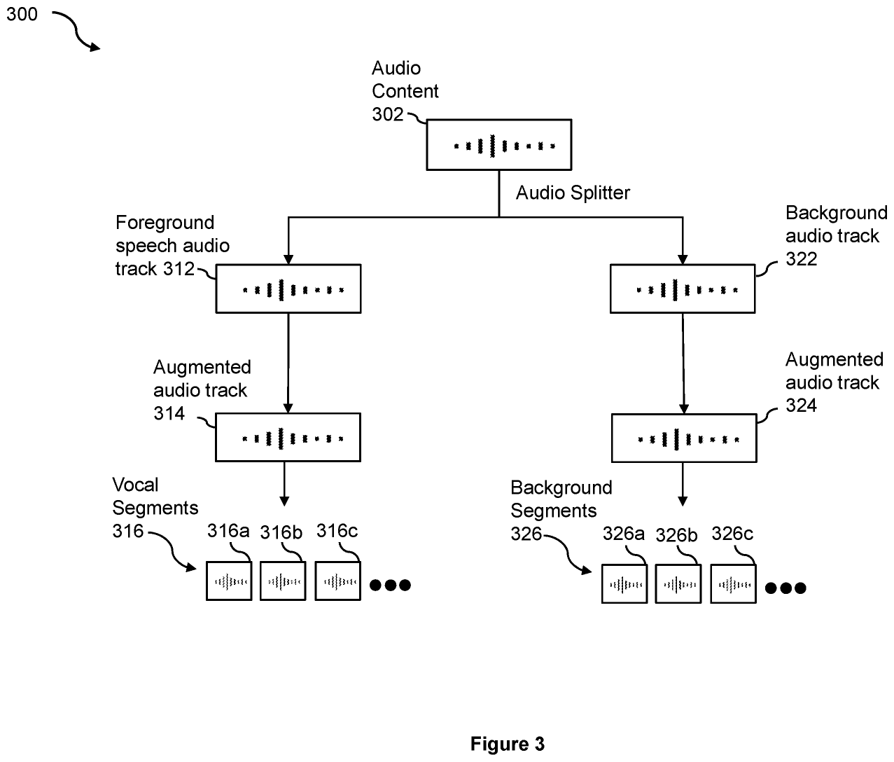

In some embodiments, the analysis manager 202 may use the correlation module 210 to determine correlations between different audio tracks, and to modify the temporal dependent features of the audio segments based on the correlations. For example, if the correlation module 210 determines that a context derived from a first audio track supports one or more temporal dependent features associated with an audio segment of a second audio track, the correlation module 210 may emphasize that one or more temporal dependent features. On the other hand, if the correlation module 210 determines that the context derived from the first audio track contradicts with one or more temporal dependent features associated with the audio segment of the second audio track, the correlation module 210 may de-emphasize the one or more temporal dependent features. Based on context derived from other audio tracks, the correlation module 210 may modify the temporal dependent features of each audio segment to generate context-aware features. The analysis manager 202 may then classify the audio data based on the context-aware features generated by the correlation module 210. The operations of each of the content splitting module 204, the segmentation module 206, the feature extraction module 208, and the correlation module 210 will be described in more detail below by way of FIGS. 3-5.

FIG. 3 illustrates operations 300 of splitting and segmenting an audio file 302 according to various embodiments of the disclosure. The content analysis module 132 may receive a classification request from the interface server 134 and/or the merchant server 120. The classification request may include a multimedia file (e.g., file containing multimedia data) and a set of criteria for classifying the multimedia file. The content analysis module 132 may extract the audio content 302, if any, from the multimedia file, such that the content analysis module 132 may use the split-and-merge approach to analyze the audio content 302. The analysis manager 202 may first use the content splitting module 204 to split the audio content 302 into multiple audio tracks based on the detected source of various sound represented in the audio content 302. In this example, the content splitting module 204 may identify a main speaker speaking in the foreground and background sound (e.g., background music, other people chatting in the background, etc.).

As such, the content splitting module 204 may divide the audio content 302 into multiple audio tracks, including a foreground speech audio track 312 corresponding to the main speaker speaking in the foreground, and a background audio track 322 corresponding to the background sound. In some embodiments, the different audio tracks are mutually exclusive from each other. In other words, the sound included in one audio track does not appear in any other audio tracks generated from the same audio content 302. While the audio content 302 is divided into only two audio tracks 312 and 322 in this example, the content splitting module 204 may divide audio data into more audio tracks (three audio tracks, five audio tracks, etc.) in other examples. For example, when it is detected that there are multiple main speakers talking within the audio content 302, the content splitting module 204 of some embodiments may generate multiple foreground speech audio track for the different main speakers. Similarly, when the content splitting module 204 identifies multiple sources of background sound, the content splitting module 204 may also generate multiple background audio tracks for background sound produced by different sound sources. By splitting the audio content 302 into different audio tracks that correspond to different sources of sound in the audio content 302, the content analysis module 132 may analyze each track individually and then determine correlations among the different tracks.

In some embodiments, after splitting the audio content 302 into different audio tracks (e.g., the foreground speech audio track 312, the background audio track 322, etc.), the analysis manager 202 may perform certain processing to the audio tracks 312 and 322 to augment the sound quality within each of the audio tracks 312 and 322. For example, the processing may include volume gain, speed adjustment, noise reduction, etc. in order to enhance and/or clarify the sound within the audio track such that the sound can be analyzed more effectively by the other modules within the content analysis module 132. For example, the analysis manager 202 may generate an augmented audio track 314 by performing the processing on the foreground speech audio track 312, and may generate an augmented audio track 324 by performing the processing on the background audio track 322.

The analysis manager 202 may then use the segmentation module 206 to divide each of the augmented audio tracks 314 and 324 into multiple audio segments. In some embodiments, the analysis manager 202 may specify one or more criteria for segmenting the audio tracks. For example, the analysis manager 202 may specific a duration for each segment (e.g., 3 seconds, 5 seconds, 10 seconds, etc.), such that the segmentation module 206 may segment each audio track into different audio segments with each audio segment having the specified duration. In some embodiments, the analysis manager 202 may determine the one or more criteria based on the content within the audio tracks. For example, the analysis manager 202 may analyze each of the audio tracks 314 and 324. Based on the analysis, the analysis manager 202 may determine several factors, such as a talking speed, a sound density, variation of sound, etc., and may determine the one or more criteria based on the factors. The analysis manager 202 may determine to have a longer duration for each audio segment when the talking speed is slower than a threshold and/or the density and variation of the sound is low. The analysis manager 202 may determine to have a shorter duration for each audio segment when the talking speed is faster than the threshold and/or the density and variation of the sound is high.

The segmentation module 206 may divide each of the audio tracks 316 and 324 into multiple audio segments. For example, the segmentation module 206 may divide the augmented audio track 314 into vocal segments 316 (including segments 316a, 316b, 316c, etc.) according to the one or more criteria, and may divide the augmented audio track 324 into background segments 326 (including segments 326a, 326b, 326c, etc.). In some embodiments, each of the segments 316a, 316b, 316c, 326a, 326b, 326c, etc. are distinct from each other and non-overlapping. The segments extracted from each audio track may be used by other modules, such as analysis manager 202, the feature extraction module 208, and the correlation module 210 to perform further analyses to the audio tracks, for classifying the audio content 302.

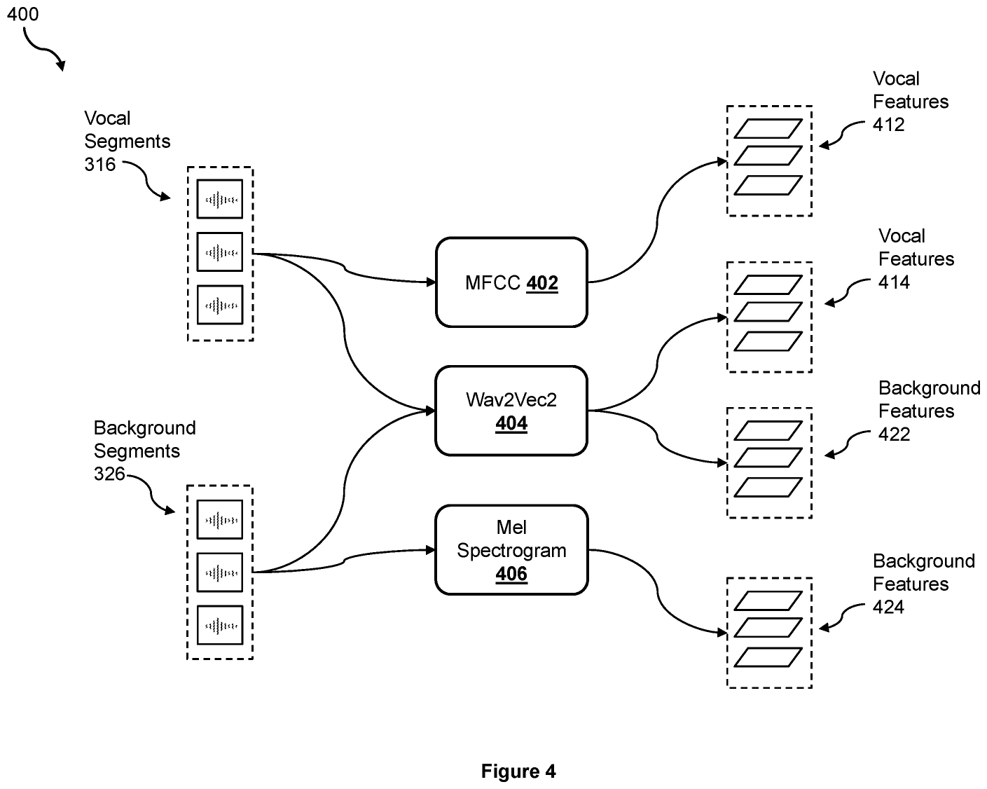

FIG. 4 illustrates operations 400 of extracting features from different audio segments according to various embodiments of the disclosure. For example, the analysis manager 202 may provide the audio segments corresponding to different audio tracks (e.g., the segments 316 corresponding to the foreground speech audio track 314, the segments 326 corresponding to the background audio track 324, etc.) to the feature extraction module 208. The feature extraction module 208 may be configured to use one or more machine learning models to extract features from each of the audio segments. In some embodiments, the feature extraction module 208 may include, or have access to, various machine learning models 402, 404, and 406. In some embodiments, the machine learning models 402, 404, and 406 have different characteristics and are configured to extract different types of features from an audio segment. For example, the machine learning models 402 and 406 may correspond to different Mel-based machine learning models that are configured to generate time-frequency representations of the sound included in each audio segment. The machine learning model 402 may correspond to a Mel-Frequency Cepstral Coefficients (MFCC) model and the machine learning model 406 may correspond to a Mel Spectrogram model. The feature extraction module 208 may also include, or have access to, a speech recognition model. For example, the machine learning model 404 may correspond to a speech recognition model (or a part of a speech recognition model) such as a Wav2Vec2 transformer model or a Wav2Vec2 conformer model, etc.

In some embodiments, the feature extraction module 208 may select, from the machine learning models 402, 404, and 406 that are accessible by the feature extraction module 208, one or more machine learning models for extracting features from each audio segment. In some embodiments, the feature extraction module 208 may determine to use a particular machine learning model (e.g., the machine learning model 404) for extracting features from all audio segments. As such, the feature extraction module 208 may provide each of the audio segments 316 and each of the audio segments 326 to the machine learning model 404. The machine learning model 404 may generate features 414 for each of the audio segments 316 and features 422 for each of the audio segments 326. In some embodiments, the machine learning model 404 may extract (or generate) multiple features from each audio segment. Since the machine learning model 404 corresponds to a speech recognition model, the features extracted by the machine learning model 404 may correspond to words being spoken by one or more persons within the audio segment.

In some embodiments, the feature extraction module 208 may select one or more machine learning models for extracting features from certain audio segments, but not other audio segments. For example, the feature extraction module 208 may select the machine learning model 406 (which may correspond to a Mel Spectrogram model) to extract features from the audio segments 326 corresponding to the background audio track 322, but not from the audio segments 316 corresponding the foreground speech audio track 312. Since the Mel-Spectrogram model is configured to transform audio signal into a multi-dimensional visualization that captures the spectrogram according to the Mel scale of the audio signal, the features generated by the machine learning model 406 provide information similar to what a human may perceive from the audio data. This is useful for analyzing general sound as the features provide comprehensive information about the sound, which may then be used to derive different data, such as speech data, sentiment data, environment data, action data, etc. Thus, the machine learning model 406 may extract features 424 from each of the audio segments 326. In some embodiments, the machine learning model 406 may extract multiple features from each of the audio segments 326. The features extracted from each of the audio segments 326 may represent various characteristics of the sound included in the audio segment, such as speech data, sentiment data, environment data, action data, etc.

On the other hand, the feature extraction module 208 may select the machine learning model 402 (which may correspond to a MFCC model) for extracting features from the audio segments 316 corresponding to the foreground speech audio track 312, but not from the audio segments 326 corresponding to the background audio track 322. Similar to the Mel-Spectrogram model, the MFCC model is also a model that is based on the Mel scale. The MFCC model may be derived from the Mel-Spectrogram model, and is configured to provide a more compressed representation of the audio signal than the Mel-Spectrogram model. By retaining only the most relevant and important information, the MFCC model is generally more efficient than the Mel-Spectrogram model, even though the outputs from the MFCC model may not be as comprehensive as the Mel-Spectrogram model. Since audio segments from the foreground speech audio track 312 include mostly a single type of sound (e.g., human speech), which typically has more structure and is less complex to analyze than other types of sound, using the MFCC model to extract features from the audio segments 316 is more efficient. Thus, the machine learning model 402 may extract features 412 from each of the audio segments 316. In some embodiments, the machine learning model 402 may extract multiple features from each of the audio segments 316. The features extracted from each of the audio segments 316 may represent various characteristics of the sound included in the audio segment, such as speech data, sentiment data, environment data, action data, etc.

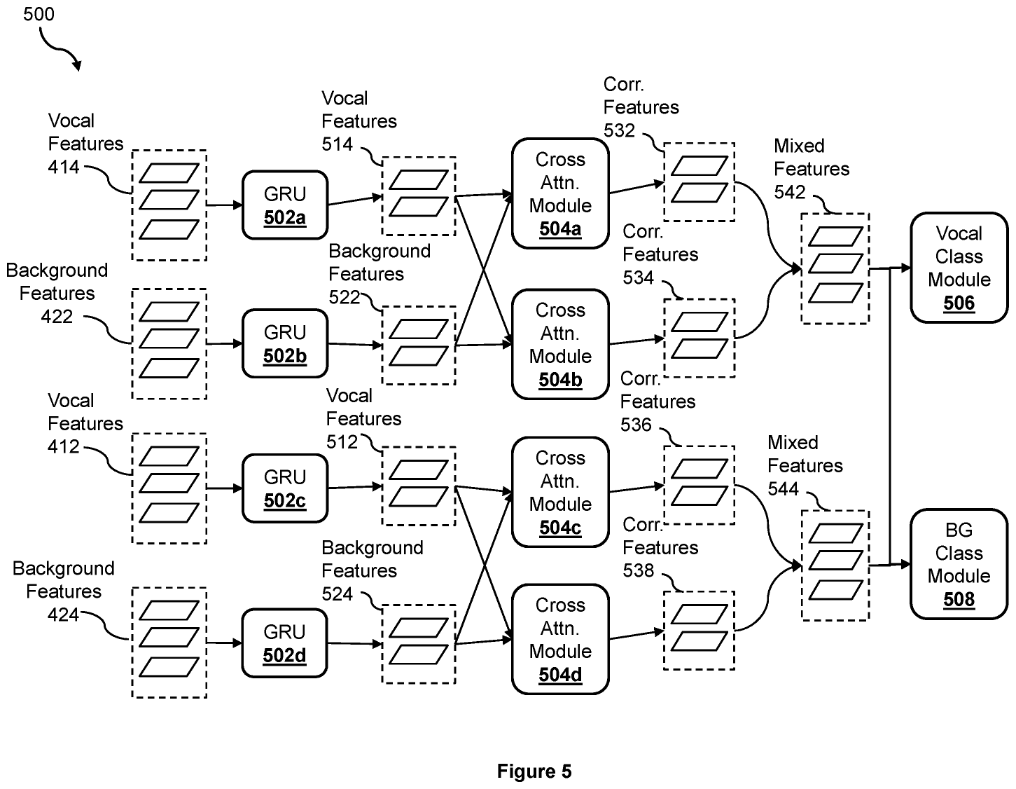

FIG. 5 illustrates operations 500 of analyzing audio segment features to classify audio data according to various embodiments of the disclosure. The analyses of the audio segment features may include multiple steps, as described in more detail below. First, the analysis manager 202 may obtain the various features, such as features 412, 414, 422, and 424 extracted from the audio segments 316 and 326 by the various machine learning models 402, 404, and 406 from the feature extraction module 208. Since the audio segments from each audio track correspond to different time periods of the same content, it has been contemplated that the audio segments may be related to one another (e.g., the audio segments may represent different portions of a speech made by a speaker). In particular, each audio segment may be associated with a temporal element (e.g., a particular timestamp, etc.) in relation to the entire audio track. For example, the audio segments 316 may include segments 316a, 316b, 316c, etc. that can be arranged in a chronological order, based on the timestamps corresponding to the segments within the audio track 312 (or augmented audio track 314). Thus, the audio segment 316a may correspond the first segment (e.g., the first portion) of the audio track 312. The audio segment 316b may correspond to a second segment that immediately follows the audio segment 316a, and the audio segment 316c may correspond to a third segment that immediate follows the audio segment 316b. The audio segments 326 may include segments 326a, 326b, 326c, etc. that can be arranged in a chronological order, based on the timestamps corresponding to the segments within the audio track 322 (or augmented audio track 324). Thus, the audio segment 326a may correspond the first segment (e.g., the first portion) of the audio track 322. The audio segment 326b may correspond to a second segment that immediately follows the audio segment 326a, and the audio segment 326c may correspond to a third segment that immediate follows the audio segment 326b.

As such, when analyzing a particular audio segment and/or a particular audio track, the analysis manager 202 may analyze the features extracted from the particular audio segment in relation to features of one or more audio segments that are related to the particular audio segment along a temporal dimension (e.g., audio segments that come immediately before or after the particular audio segment in the audio track, etc.). In some embodiments, the analysis manager 202 may use a recurrent neural network (e.g., gated recurrent units (GRUs) 502a, 502b, 502c, 502d, etc.) to transform the features extracted from the audio segments associated with an audio track to temporal dependent features. For example, the analysis manager 202 may provide the features 414 associated with the audio segments 316, one audio segment at a time in a chronological order, to the recurrent neural network. The analysis manager 202 may provide the features associated with the audio segment 316a to the GRU 502a first, and then the features associated with the audio segment 316b, and then the features associated with the audio segment 316c and so forth.

When features associated with the audio segment 316a are provided to the GRU 502a, the GRU 502a will only analyze the features associated with the audio segment 316a, and generate a set of temporal dependent features for the audio segment 316a. The analysis manager 202 may then provide features associated with the audio segment 316b to the GRU 502a. The GRU 502a may analyze the features associated with the audio segment 316b in relation to the features associated with the audio segment 316a, and may generate a set of temporal dependent features for the audio segment 316b based on the features associated with the audio segment 316a and the features associated with the audio segment 316b. The analysis manager 202 may then provide features associated with the audio segment 316c to the GRU 502a. The GRU 502a may analyze the features associated with the audio segment 316c in relation to the features associated with the audio segment 316a and the features associated with the audio segment 316b, and may generate a set of temporal dependent features for the audio segment 316c based on the features associated with the audio segment 316a, the features associated with the audio segment 316b, and the features associated with the audio segment 316c. In some embodiments, when generating the temporal dependent features for a particular audio segment (e.g., the audio segment 316c), the GRU 502a may assign a larger weight to features of other audio segments that are chronologically closer to the particular audio segment (e.g., the audio segment 316b) and a smaller weight to features of other audio segments that are chronologically farther away from the particular audio segment (e.g., the audio segment 316a).

The audio analysis system may continue to provide features associated with subsequent audio segments of the audio segments 316 associated with the foreground speech audio track 312 to the GRU 502a. The GRU 502a may analyze each audio segment based on the features associated with the audio segment and the features associated with one or more previous audio segments to generate a set of temporal dependent features for the audio segment. Since the GRU 502a takes into account features associated with previous (and/or subsequent) audio segments when analyzing a particular audio segment, the GRU 502a may use the context derived from the previous audio segments to generate the temporal dependent features for the particular audio segment. As such, the temporal dependent features generated for each particular audio segment may represent the characteristics of the audio signals within the audio segment using the context of the audio signals from the audio segment(s) that comes before it.

Generating temporal dependent features for the audio segments is advantageous because it is generally more accurate to understand and/or decipher a sound (e.g., a word, a phrase, a noise, etc.) with information related to the sound that precedes it (e.g., the words or phrase that precedes it, a sound that precedes it, etc.). For example, an audio segment that includes the sound of a gunshot may indicate that a violent event has occurred, or that a television in the background was broadcasting an action movie on the television. Analyzing that audio segment in a vacuum may not yield a definitive answer. However, the sound that precedes the audio segment may provide additional context (e.g., lots of people screaming or not, different style of people talking suggesting a change of television channels, etc.) to aid the recurrent neural network and/or the audio analysis system to understand the sound in this audio segment. By analyzing the features 414 extracted from the audio segments 316 in a chronological order, the GRU 502a may generate temporal dependent features 514.

The analysis manager 202 may use the same techniques to generate temporal dependent features 522 by providing the features 422 extracted by the machine learning model 404 from the audio segments 326 corresponding to the background audio track 322 to GRU 502b in a sequential manner. The analysis manager 202 may also provide the features 412 extracted by the machine learning model 402 from the audio segments 316 corresponding to the foreground speech audio track 312 to the GRU 502c to generate temporal dependent features 512. The analysis manager 202 may also provide the features 424 extracted by the machine learning model 406 from the audio segments 326 corresponding to the background audio track 322 to the GRU 502d to generate temporal dependent features 524. In some embodiments, the GRUs 502a, 502b, 502c, and 502d correspond to the same recurrent neural network.

In some embodiments, once the temporal dependent features are generated for each audio track, the analysis manager 202 may use the correlation module 210 to determine correlations among the different audio tracks (e.g., the foreground speech audio track 312, the background audio track 322, etc.) based on the temporal dependent features 514, 522, 512, and 524 generated by the GRUs 502a, 502b, 502c, and 502d. For example, background sound associated with people fighting (e.g., shoving, pushing, falling, etc.) often accompanies with offensive language in a scene where someone is being bullied. In another example, background sound that corresponds to a person falling onto the ground that accompanies with offensive language may indicate that a violent event (e.g., a physical altercation between two people) may happen. On the other hand, the same background sound that corresponds to a person falling onto the ground that accompanies with voice made by people caught in surprise may indicate that the person might have fallen onto the ground by accident. Thus, the correlations between the different audio tracks 312 and 322 (e.g., whether the sound from one audio track supports or contradicts the sound from another audio track) may enable the analysis manager 202 to detect the events that occur within the audio content 302 more accurately, and provide a more accurate classification as a result.

In some embodiments, the correlation module 210 may use cross attention modules 504a, 504b, 504c, and 504d to determine correlations (or lack thereof) between different audio tracks 312 and 322. In some embodiments, the cross attention modules 504a, 504b, 504c, and 504d correspond to the same cross attention module. Each of the cross attention modules 504a, 504b, 504c, and 504d may be configured to accept temporal dependent features associated with two or more audio tracks. For example, the correlation module 210 may provide temporal dependent features associated with a primary audio track (e.g., the temporal dependent features 522 associated with the background audio track 322) and temporal dependent features associated with a secondary audio track (e.g., the temporal dependent features 514 associated with the foreground speech audio track 312) as input data to a cross attention module (e.g., the cross attention module 504b). In some embodiments, the temporal dependent features provided to the cross attention module are all extracted by the same type of machine learning models, so that the temporal dependent features can be compared against each other. For example, the correlation module 210 may provide the temporal dependent features 514 and 522 to cross attention modules 504a and/or 504b as input data to determine correlations between the audio tracks 312 and 322 since the temporal dependent features 514 and 522 were derived from features extracted by a speech recognition model. The correlation module 210 may also provide the temporal dependent features 512 and 524 to cross attention modules 504c and/or 504d as input data to determine correlations between the audio tracks 312 and 322 since the temporal dependent features 512 and 524 were derived from features extracted by Mel-based models (e.g., a Mel Spectrogram model and an MFCC model).

Upon receiving the temporal dependent features 522 associated with the background audio track 322 (as the primary audio track) and the temporal dependent features 514 associated with the foreground speech audio track 312 (as the secondary audio track), the cross attention module 504b may analyze (and modify) the temporal dependent features 522 associated with the primary audio track based on the temporal dependent features 514 associated with the secondary audio track. In some embodiments, the cross attention module 504b may compare the temporal dependent features from each audio segment from the primary audio track against temporal dependent features from every audio segment from the secondary audio track to determine whether correlations exist between the primary audio track and the secondary audio track.

If the cross attention module 504b determines that the temporal dependent features 514 associated with the secondary audio track supports one or more of the temporal dependent features 522 associated with the primary audio track (e.g., the context determined based on the audio segments 316 from the secondary audio track is consistent with one or more of the temporal dependent features 522 associated with the primary audio track, such as when the offensive language included in the foreground speech audio track 312 is consistent with a feature that suggests a violent event based on the background sound), the cross attention module 504b may emphasize and/or highlight the one or more of the temporal dependent features 522. For example, the cross attention module 504b may strengthen the one or more temporal dependent features (e.g., by increasing the values in the one or more temporal dependent features, etc.).

On the other hand, if the cross attention module 504b determines that the temporal dependent features 514 associated with the secondary audio track contradicts with one or more of the temporal dependents features 522 associated with the primary audio track (e.g., the context determined based on the audio segments 316 from the secondary audio track is inconsistent with one or more of the temporal dependent features 522 associated with the primary audio track, such as when the calm or surprised voice and non-offensive language included in the foreground speech audio track is inconsistent with a feature that suggests a violent event based on the background sound), the cross attention module 504b may deemphasize (e.g., by reducing the values of the features, etc.) and/or remove the one or more of the temporal dependent features.

The cross attention module 504b may output context-aware features 534 associated with the primary audio track based on modifying the temporal dependent features 522. Based on the correlation processing performed by the cross attention module 504b, the temporal dependent features 522 associated with the primary audio track have been modified to reflect the correlations detected between the primary audio track and the secondary audio track, such that the context aware features 534 associated with the primary audio track have become more accurate in representing the events occurred when the audio content 302 was captured.

In some embodiments, the correlation module 210 repeats the same process (e.g., perform a second iteration of the correlation process) on the same temporal dependent features 514 and 522 by switching the primary audio track and the secondary audio track. Thus, the primary audio track used in the first iteration becomes the secondary audio track in the second iteration, and the secondary audio track used in the first iteration becomes the primary audio track in the second iteration. By performing the correlation process in multiple iterations using different audio tracks as the primary audio track, the audio analysis system may generate context-aware features for each of the audio tracks associated with the audio data. As such, the correlation module 210 may provide temporal dependent features 514 associated with the foreground speech audio track 312 as the primary audio track and provide the temporal dependent features 522 associated with the background audio track 322 as the secondary audio track to a cross attention module (e.g., the cross attention module 504a). The cross attention module 504a may analyze (and modify) the temporal dependent features 514 associated with the primary audio track based on the temporal dependent features 522 associated with the secondary audio track using the techniques disclosed herein, and generate context-aware features 532.

Similarly, the correlation module 210 may use the cross attention modules 504c and 504d to modify the temporal dependent features 512 and 524 by providing the temporal dependent features 512 and 524 to the cross attention module 504c and 504d in different iterations. During the first iteration, the correlation module 210 may provide, as input data to the cross attention module 504c, the temporal dependent features 512 as features associated with the primary audio track and the temporal dependent features 524 as features associated with the secondary audio track. The cross attention module 504c may modify the temporal dependent features 512 to generate the context-aware features 536 based on the temporal dependent features 524. During the second iteration, the correlation module 210 may provide, as input data to the cross attention module 504d, the temporal dependent features 524 as features associated with the primary audio track and the temporal dependent features 512 as features associated with the secondary audio track. The cross attention module 504d may modify the temporal dependent features 524 to generate the context-aware features 538 based on the temporal dependent features 512.

In some embodiments, the analysis manager 202 may combine the context-aware features 532 and 534 to generate mixed features 542, and may combine the context-aware features 536 and 538 to generate mixed features 544. The analysis manager 202 may provide the mixed features 542 and 544 to each of a vocal classification module 506 and a background classification module 508. The vocal classification module 506 may be configured to generate a speech classification for the speech portion of the audio content 302 based on the mixed features 542 and 544 and the set of criteria. The background classification module 508 may be configured to generate a background classification for the background portion of the audio content 302 based on the mixed features 542 and 544 and the set of criteria. For example, when the set of criteria is related to local laws/regulations and/or internal policies, the speech classification and background classification may indicate whether the speech or non-speech portions of the audio data are in compliance with the local laws/regulations and/or the internal policies.

If the analysis manager 202 determines that the audio content 302 is in compliance with the local laws/regulations and/or the internal policies, the analysis manager 202 may cause the publishing of the audio content 302 to a site (e.g., a website, a mobile application, etc.) associated with the service provider server 130 or the merchant server 120. On the other hand, if the analysis manager 202 determines that the audio content 302 is not in compliance with the local laws/regulations and/or the internal policies, the analysis manager 202 may withdraw or otherwise not publish the audio content 302 on the site. The analysis manager 202 may also transmit the audio data to another computer module (or a human reviewer) of the service provider server 130 or the merchant server 120 for further processing the audio data (e.g., to scrub the audio data, to remove the sound that is not in compliance with the laws/regulations, etc.).

In some embodiments, when the speech classification and/or the non-speech classification indicates that one or more portions of the audio data include non-compliant sound, the classifications may also indicate which portion(s) (e.g., which audio segments) including the non-compliant sound. The analysis manager 202 may flag that portion(s) (e.g., the audio segment(s)) in the audio content 302. For example, the analysis manager 202 may modify that particular audio segment(s) (e.g., adding an indicator such as a specific alarm or beep to the audio segment(s), adding a visual indicator on the corresponding video portion of a video clip, etc.) before transmitting the audio data (or video data) to the other computer module for further processing.

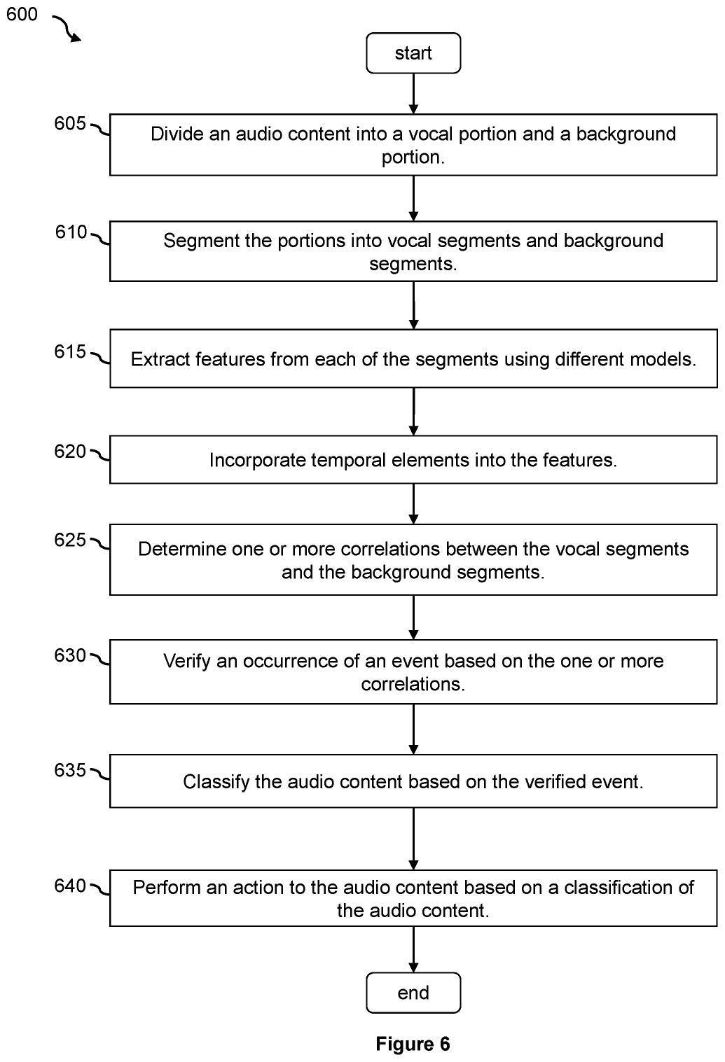

FIG. 6 illustrates a process 600 for performing audio data classification according to various embodiments of the disclosure. In some embodiments, at least a portion of the process 600 may be performed by the content analysis module 132. The process 600 begins by dividing (at step 605) an audio content into a vocal portion and a background portion and segments (at step 610) the portions into vocal segments and background segments. For example, the analysis manager 202 may use the content splitting module 204 to split the audio content 302 into different audio tracks (e.g., a foreground speech audio track 312 and a background audio track 322). In some embodiments, the analysis manager 202 may also perform one or more processes to augment the audio tracks 312 and 322 to generate automated audio tracks 314 and 324, respectively. The analysis manager 202 may then use the segmentation module 206 to segment each of the audio tracks 314 and 324. For example, the segmentation module 206 may divide the audio track 314 into vocal segments 316, and may divide the audio track 324 into background segments 326 according to a duration criterion.

The process 600 then extracts (at step 615) features from each of the segments using different models and incorporates (at step 620) temporal elements into the features. For example, the analysis manager 202 may use the feature extraction module 208 to extract features from each of the vocal segments 316 and extract features from each of the background segments 326. In some embodiments, the feature extraction module 208 may use different models to extract features from the same segment. For example, the feature extraction module 208 may use the machine learning model 402 (e.g., an MFCC model) to extract time-frequency representations of the sound from each of the vocal segments 316. The feature extraction module 208 may use the machine learning model 404 (e.g., a Wav2Vec2) model to extract word features from each of the vocal segments 316. The feature extraction module 208 may use the machine learning model 406 (e.g., a Mel Spectrogram model) to extract time-frequency representations of the sound from each of the background segments 326. The feature extraction module 208 may use the machine learning model 404 (e.g., a Wav2Vec2) model to extract word features from each of the background segments 326.

The process 600 incorporates (at step 620) temporal elements into the features. For example, the analysis manager 202 may provide the features associated with the segments, one at a time in a chronological order, to a recurrent neural network (e.g., the GRUs 502a, 502b, 502c, and 502d). Based on the features associated with the segments, the recurrent neural network may incorporate temporal context into the features of the segments based on features of previous segments.

The process 600 then determines (at step 625) one or more correlations between the vocal segments and the background segments and verifies (at step 630) an occurrence of an event based on the one or more correlations. For example, the analysis manager 202 may use the correlation module 210 to determine one or more correlations between the different audio tracks 312 and 322. Specifically, the correlation module 210 may provide features associated with different audio tracks to a cross attention module (e.g., the cross attention modules 504a, 504b, 504c, and 504d). The correlation module 210 may designate the different audio tracks as a primary audio track and a secondary audio track. The cross attention modules may use the features associated with the secondary audio track to modify the features associated with the primary audio track. For example, if a cross attention module determines that the features associated with the secondary audio track are consistent with (e.g., support) one or more features of the primary audio track, the cross attention module may enhance the one or more features. On the other hand, if a cross attention module determines that the features associated with the secondary audio track are inconsistent with (e.g., contradict) one or more features of the primary audio track, the cross attention module may de-emphasize the one or more features. The analysis manager 202 may repeat the correlation process by switching the primary audio track and the secondary audio track.

In some embodiments, the analysis manager 202 may detect an occurrence of an event based on one or more features from an audio track (e.g., the background audio track 322). If the correlation module 210 determines one or more correlation between features from another audio track (e.g., the foreground speech audio track 312) and the event, the analysis manager 202 may verify the occurrence of the event.

The process 600 then classifies (at step 635) the audio content based on the verified event and performs (at step 640) an action to the audio content based on a classification of the audio content. For example, the analysis manager 202 may classify the audio content 302 based on a set of criteria (e.g., determines whether the audio content 302 includes prohibited audio content, etc.). If the analysis manager 202 determines that the audio content 302 satisfies the set of criteria, the analysis manager 202 may publish the audio content 302 to a site associated with the service provider server 130 or the merchant server 120. On the other hand, if the analysis manager 202 determines that the audio content 302 does not satisfy the set of criteria, the analysis manager 202 may modify at least a portion of the audio content 302 (e.g., removing the segment(s) that fails the set of criteria, flagging the segment(s) that fails the set of criteria, etc.) and/or provide the modified audio content to another module for further processing.

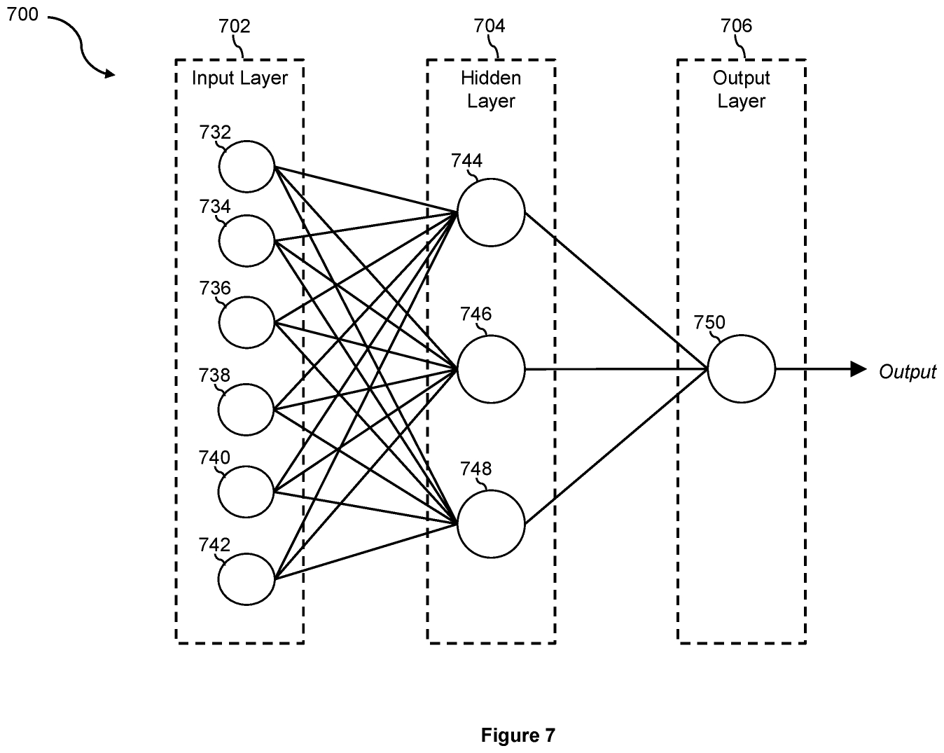

FIG. 7 illustrates an example artificial neural network 700 that may be used to implement a machine learning model, such as the machine learning models 402, 404, and 406, the GRUs 502a, 502b, 502c, and 502d, the cross attention module 504a, 504b, 504c, and 504d, and the classification modules 506 and 508, etc. As shown, the artificial neural network 700 includes three layers—an input layer 702, a hidden layer 704, and an output layer 706. Each of the layers 702, 704, and 706 may include one or more nodes (also referred to as “neurons”). For example, the input layer 702 includes nodes 732, 734, 736, 738, 740, and 742, the hidden layer 704 includes nodes 744, 746, and 748, and the output layer 706 includes a node 750. In this example, each node in a layer is connected to every node in an adjacent layer via edges and an adjustable weight is often associated with each edge. For example, the node 732 in the input layer 702 is connected to all of the nodes 744, 746, and 748 in the hidden layer 704. Similarly, the node 744 in the hidden layer is connected to all of the nodes 732, 734, 736, 738, 740, and 742 in the input layer 702 and the node 750 in the output layer 706. While each node in each layer in this example is fully connected to the nodes in the adjacent layer(s) for illustrative purpose only, it has been contemplated that the nodes in different layers can be connected according to any other neural network topologies as needed for the purpose of performing a corresponding task.

The hidden layer 704 is an intermediate layer between the input layer 702 and the output layer 706 of the artificial neural network 700. Although only one hidden layer is shown for the artificial neural network 700 for illustrative purpose only, it has been contemplated that the artificial neural network 700 used to implement any one of the computer-based models may include as many hidden layers as necessary. The hidden layer 704 is configured to extract and transform the input data received from the input layer 702 through a series of weighted computations and activation functions.

In this example, the artificial neural network 700 receives a set of inputs and produces an output. Each node in the input layer 702 may correspond to a distinct input. For example, when the artificial neural network 700 is used to implement any one of the machine learning models 402, 404, and 406, the nodes in the input layer 702 may correspond to different audio signals of an audio segment. When the artificial neural network 700 is used to implement any one of the GRUs 502a, 502b, 502c, and 502d, the nodes in the input layer 702 may correspond to different features (e.g., different embeddings) extracted from an audio segment. When the artificial neural network 700 is used to implement any one of the cross attention modules 504a, 504b, 504c, and 504d, the nodes in the input layer 702 may correspond to different features (e.g., different embeddings) extracted from an audio segment. When the artificial neural network 700 is used to implement any one of the classification modules 506 and 508, the nodes in the input layer 702 may correspond to different mixed features (e.g., different embeddings).

In some examples, each of the nodes 744, 746, and 748 in the hidden layer 704 generates a representation, which may include a mathematical computation (or algorithm) that produces a value based on the input values received from the nodes 732, 734, 736, 738, 740, and 742. The mathematical computation may include assigning different weights (e.g., node weights, edge weights, etc.) to each of the data values received from the nodes 732, 734, 736, 738, 740, and 742, performing a weighted sum of the inputs according to the weights assigned to each connection (e.g., each edge), and then applying an activation function associated with the respective node (or neuron) to the result. The nodes 744, 746, and 748 may include different algorithms (e.g., different activation functions) and/or different weights assigned to the data variables from the nodes 732, 734, 736, 738, 740, and 742 such that each of the nodes 744, 746, and 748 may produce a different value based on the same input values received from the nodes 732, 734, 736, 738, 740, and 742. The activation function may be the same or different across different layers. Example activation functions include but not limited to Sigmoid, hyperbolic tangent, Rectified Linear Unit (ReLU), Leaky ReLU, Softmax, and/or the like. In this way, after a number of hidden layers, input data received at the input layer 702 is transformed into rather different values indicative data characteristics corresponding to a task that the artificial neural network 700 has been designed to perform.

In some examples, the weights that are initially assigned to the input values for each of the nodes 744, 746, and 748 may be randomly generated (e.g., using a computer randomizer). The values generated by the nodes 744, 746, and 748 may be used by the node 750 in the output layer 706 to produce an output value (e.g., a response to a user query, embeddings, a classification prediction, etc.) for the artificial neural network 700. The number of nodes in the output layer depends on the nature of the task being addressed. For example, in a binary classification problem, the output layer may consist of a single node representing the probability of belonging to one class. In a multi-class classification problem, the output layer may have multiple nodes, each representing the probability of belonging to a specific class.

When the artificial neural network 700 is used to implement any one of the machine learning models 402, 404, and 406, the output node 750 may be configured to generate features for different audio segments. When the artificial neural network 700 is used to implement any one of the GRUs 502a, 502b, 502c, and 502d, the output node 750 may be configured to generate temporal dependent features based on features extracted from sequential audio segments. When the artificial neural network 700 is used to implement any one of the cross attention modules 504a, 504b, 504c, and 504d, the output node 750 may be configured to generate context-aware features. When the artificial neural network 700 is used to implement any one of the classification modules 506 and 508, the output node 750 may be configured to generate a binary classification (or a classification score).

In some examples, the artificial neural network 700 may be implemented on one or more hardware processors, such as CPUs (central processing units), GPUs (graphics processing units), FPGAs (field-programmable gate arrays), Application-Specific Integrated Circuits (ASICs), dedicated AI accelerators like TPUs (tensor processing units), and specialized hardware accelerators designed specifically for the neural network computations described herein, and/or the like. Example specific hardware for neural network structures may include, but not limited to Google Edge TPU, Deep Learning Accelerator (DLA), NVIDIA AI-focused GPUs, and/or the like. The hardware used to implement the neural network structure is specifically configured based on factors such as the complexity of the neural network, the scale of the tasks (e.g., training time, input data scale, size of training dataset, etc.), and the desired performance.

The artificial neural network 700 may be trained by using training data based on one or more loss functions and one or more hyperparameters. By using the training data to iteratively train the artificial neural network 700 through a feedback mechanism (e.g., comparing an output from the artificial neural network 700 against an expected output, which is also known as the “ground-truth” or “label”), the parameters (e.g., the weights, bias parameters, coefficients in the activation functions, etc.) of the artificial neural network 700 may be adjusted to achieve an objective according to the one or more loss functions and based on the one or more hyperparameters such that an optimal output is produced in the output layer 706 to minimize the loss in the loss functions. Given the loss, the negative gradient of the loss function is computed with respect to each weight of each layer individually. Such negative gradient is computed one layer at a time, iteratively backward from the last layer (e.g., the output layer 706 to the input layer 702 of the artificial neural network 700). These gradients quantify the sensitivity of the network's output to changes in the parameters. The chain rule of calculus is applied to efficiently calculate these gradients by propagating the gradients backward from the output layer 706 to the input layer 702.

Parameters of the artificial neural network 700 are updated backwardly from the last layer to the input layer (backpropagating) based on the computed negative gradient using an optimization algorithm to minimize the loss. The backpropagation from the last layer (e.g., the output layer 706) to the input layer 702 may be conducted for a number of training samples in a number of iterative training epochs. In this way, parameters of the artificial neural network 700 may be gradually updated in a direction to result in a lesser or minimized loss, indicating the artificial neural network 700 has been trained to generate a predicted output value closer to the target output value with improved prediction accuracy. Training may continue until a stopping criterion is met, such as reaching a maximum number of epochs or achieving satisfactory performance on the validation data. At this point, the trained network can be used to make predictions on new, unseen data, such as to classify audio data, etc. In some embodiments, the entire framework (e.g., the content analysis module 132) may be trained collectively using previously classified audio data.

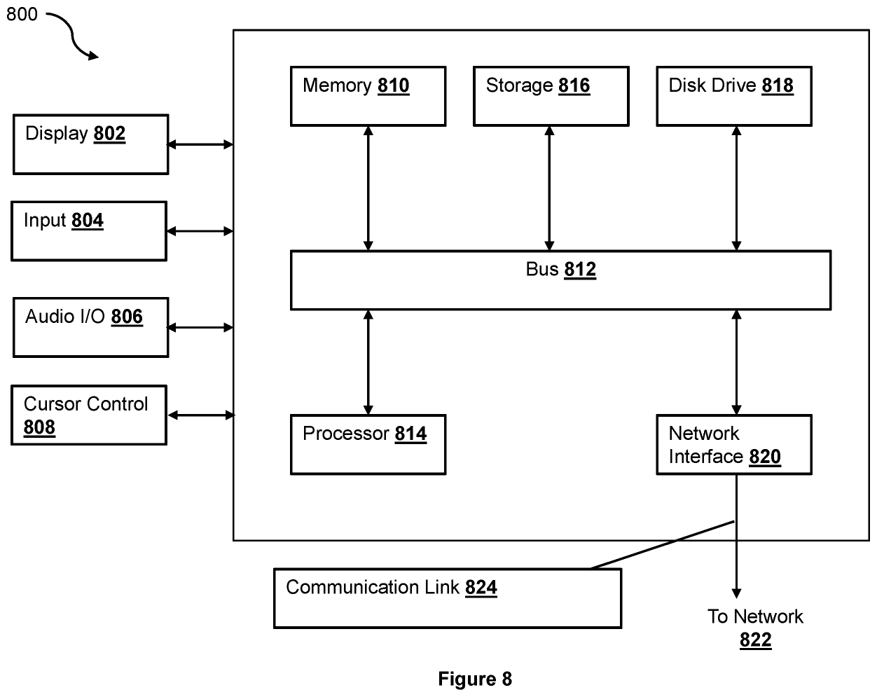

FIG. 8 is a block diagram of a computer system 800 suitable for implementing one or more embodiments of the present disclosure, including the service provider server 130, the merchant server 120, and the user devices 110, 180, and 190. In various implementations, each of the user devices 110, 180, and 190 may include a mobile cellular phone, personal computer (PC), laptop, wearable computing device, etc. adapted for wireless communication, and each of the service provider server 130 and the merchant server 120 may include a network computing device, such as a server. Thus, it should be appreciated that the devices 110, 120, 130, 180, and 190 may be implemented as the computer system 800 in a manner as follows.

The computer system 800 includes a bus 812 or other communication mechanism for communicating information data, signals, and information between various components of the computer system 800. The components include an input/output (I/O) component 804 that processes a user (i.e., sender, recipient, service provider) action, such as selecting keys from a keypad/keyboard, selecting one or more buttons or links, etc., and sends a corresponding signal to the bus 812. The I/O component 804 may also include an output component, such as a display 802 and a cursor control 808 (such as a keyboard, keypad, mouse, etc.). The display 802 may be configured to present a login page for logging into a user account or a checkout page for purchasing an item from a merchant. An optional audio input/output component 806 may also be included to allow a user to use voice for inputting information by converting audio signals. The audio I/O component 806 may allow the user to hear audio. A transceiver or network interface 820 transmits and receives signals between the computer system 800 and other devices, such as another user device, a merchant server, or a service provider server via a network 822. In one embodiment, the transmission is wireless, although other transmission mediums and methods may also be suitable. A processor 814, which can be a micro-controller, digital signal processor (DSP), or other processing component, processes these various signals, such as for display on the computer system 800 or transmission to other devices via a communication link 824. The processor 814 may also control transmission of information, such as cookies or IP addresses, to other devices.

The components of the computer system 800 also include a system memory component 810 (e.g., RAM), a static storage component 816 (e.g., ROM), and/or a disk drive 818 (e.g., a solid-state drive, a hard drive). The computer system 800 performs specific operations by the processor 814 and other components by executing one or more sequences of instructions contained in the system memory component 810. For example, the processor 814 can perform the audio data classification functionalities described herein, for example, according to the process 600.

Logic may be encoded in a computer readable medium, which may refer to any medium that participates in providing instructions to the processor 814 for execution. Such a medium may take many forms, including but not limited to, non-volatile media, volatile media, and transmission media. In various implementations, non-volatile media includes optical or magnetic disks, volatile media includes dynamic memory, such as the system memory component 810, and transmission media includes coaxial cables, copper wire, and fiber optics, including wires that comprise the bus 812. In one embodiment, the logic is encoded in non-transitory computer readable medium. In one example, transmission media may take the form of acoustic or light waves, such as those generated during radio wave, optical, and infrared data communications.

Some common forms of computer readable media include, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, or any other medium from which a computer is adapted to read.

In various embodiments of the present disclosure, execution of instruction sequences to practice the present disclosure may be performed by the computer system 800. In various other embodiments of the present disclosure, a plurality of computer systems 800 coupled by the communication link 824 to the network (e.g., such as a LAN, WLAN, PTSN, and/or various other wired or wireless networks, including telecommunications, mobile, and cellular phone networks) may perform instruction sequences to practice the present disclosure in coordination with one another.

Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the spirit of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa.

Software in accordance with the present disclosure, such as program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

The various features and steps described herein may be implemented as systems comprising one or more memories storing various information described herein and one or more processors coupled to the one or more memories and a network, wherein the one or more processors are operable to perform steps as described herein, as non-transitory machine-readable medium comprising a plurality of machine-readable instructions which, when executed by one or more processors, are adapted to cause the one or more processors to perform a method comprising steps described herein, and methods performed by one or more devices, such as a hardware processor, user device, server, and other devices described herein.

What is claimed is:

1. A system, comprising:
a non-transitory memory; and
one or more hardware processors coupled with the non-transitory memory and configured to read instructions from the non-transitory memory to cause the system to perform operations comprising:
splitting an audio content into a vocal portion and a background portion;
extracting vocal features from the vocal portion and extracting background features from the background portion;
determining one or more correlations between the vocal portion of the audio content and the background portion of the audio content based on the vocal features and the background features; and
classifying the audio content based on the one or more correlations.

2. The system of claim 1, wherein the classifying comprises classifying the audio content as a first audio type based on the one or more correlations, and wherein the operations further comprise:
incorporating, into the audio content, a signal indicating the first audio type.

3. The system of claim 1, wherein the classifying comprises determining that a first segment of the audio content comprises audio data corresponding to a first audio type, and wherein the operations further comprise:
modifying first segment of the audio content based on the first audio type.

4. The system of claim 3, wherein the modifying comprises removing the first segment from the audio content.

5. The system of claim 1, wherein the operations further comprise:
augmenting the vocal portion and the background portion.

6. The system of claim 1, wherein the operations further comprise:
segmenting the vocal portion into a plurality of vocal segments; and
segmenting the background portion into a plurality of background segments, wherein the determining the one or more correlations comprises determining a corresponding correlation score between a first vocal segment in the plurality of vocal segments and each corresponding background segment in the plurality of background segments.

7. The system of claim 6, wherein the operations further comprise:
determining a correlation between the first voice segment and a first corresponding background segment from the plurality of background segments based on the corresponding correlation score.

8. A method, comprising:
dividing audio data associated with a digital content into a first audio track and a second audio track;
extracting a first plurality of audio features from the first audio track and extracting a second plurality of audio features from the second audio track;
determining one or more correlations between the first audio track and the second audio track based on the first plurality of audio features and the second plurality of audio features; and
classifying the digital content based on the one or more correlations.

9. The method of claim 8, further comprising
determining an occurrence of an event based on the second plurality of audio features extracted from the second audio track, wherein the one or more correlations indicate that one or more features from the first plurality of audio features are consistent with the occurrence of the event.

10. The method of claim 9, wherein the classifying the digital content is based on the occurrence of the event.

11. The method of claim 8, further comprising:
incorporating, using a gated recurrent unit (GRU), temporal information into the first plurality of audio features.

12. The method of claim 8, wherein the first plurality of audio features comprises at least one of a word feature, a sentiment feature, or a tone feature.

13. The method of claim 8, wherein the extracting the first plurality of audio features from the first portion of the audio data comprises:
extracting a first portion of the first plurality of audio features from the first audio track using a first machine learning model; and
extracting a second portion of the first plurality of audio features from the first audio track using a second machine learning model different from the first machine learning model.

14. The method of claim 8, further comprising:
segmenting the first audio track into a first plurality of audio segments; and
segmenting the second audio track into a second plurality of audio segments, wherein the determining the one or more correlations comprises determining a corresponding correlation score between a first audio segment in the first plurality of audio segments and each corresponding audio segment in the second plurality of audio segments.

15. A non-transitory machine-readable medium having stored thereon machine-readable instructions executable to cause a machine to perform operations comprising:
splitting audio data into a first portion and a second portion;
extracting a first plurality of audio features from the first portion of the audio data and extracting a second plurality of audio features from the second portion of the audio data;
comparing the first plurality of audio features with the second plurality of audio features;
determining, based on the comparing, one or more correlations between the first portion of the audio data and the second portion of the audio; and
classifying the audio data based on the one or more correlations.

16. The non-transitory machine-readable medium of claim 15, wherein the operations further comprise:
segmenting the first portion of the audio data into a first plurality of audio segments; and
segmenting the second portion of the audio data into a second plurality of audio segments, wherein the determining the one or more correlations comprises determining a corresponding correlation score between a first audio segment in the first plurality of audio segments and each corresponding audio segment in the second plurality of audio segments.

17. The non-transitory machine-readable medium of claim 16, wherein the operations further comprise:
determining a correlation between the first audio segment and a particular corresponding audio segment from the second plurality of audio segments based on the corresponding correlation score.

18. The non-transitory machine-readable medium of claim 17, wherein the operations further comprise:
detecting an occurrence of an event based on one or more features extracted from the particular corresponding audio segment; and
classifying the event based on the first audio segment and the correlation between the first audio segment and the particular corresponding segment, wherein the classifying the audio data is further based on the classifying the event.

19. The non-transitory machine-readable medium of claim 15, wherein the operations further comprise:
incorporating corresponding temporal information into each audio feature in the first plurality of audio features based on one or more other audio features in the first plurality of audio features.

20. The non-transitory machine-readable medium of claim 15, wherein the first plurality of audio features comprises at least one of a text feature, a sentiment feature, or a tone feature.
